(19) United States
(12) Patent Application Publication
(10) Pub. No.: US 2020/0381765 A1
(43) Pub. Date: Dec. 3, 2020

(54) BATTERY

(71) Applicant: DONGGUAN AMPEREX TECHNOLOGY LIMITED, Dongguan (CN)

(72) Inventors: Chao Yang, Dongguan (CN); Yanan Zhang, Dongguan (CN); Jinhui Chen, Dongguan (CN); Chunhua Bian, Dongguan (CN)

(21) Appl. No.: 16/733,096

(22) Filed: Jan. 2, 2020

(30) Foreign Application Priority Data
May 28, 2019 (CN) 201920789420.0

(51) Int. Cl. H01M 10/04; H01M 2/26; H01M 10/0587; H01M 2/02; H01M 2/08; H01M 10/0525

(52) U.S. Cl. CPC H01M 10/0431; H01M 2/263; H01M 10/0587; H01M 10/0525; H01M 2/021; H01M 2/08; H01M 2/0212

(57) ABSTRACT

A battery includes an electrode assembly and a protective layer, the electrode assembly includes a first electrode sheet, a first tab, a second electrode sheet and a second tab. The first tab is electrically connected to the first electrode sheet. The second tab is electrically connected to the second electrode sheet, and the protective layer covers at least partial surface of the first tab and at least partial surface of the second tab.

### CROSS-REFERENCE TO RELATED APPLICATION

This application claims priority to and benefits of Chinese Patent Application Serial No. 201920789420.0, filed with the National Intellectual Property Administration of People's Republic of China on May 28, 2019, all which are incorporated herein by reference.

### FIELD

The present disclosure relates to the field of energy storage devices, and more particularly to a battery.

### BACKGROUND

Multi-tab winding structure is currently widely used in batteries, and with the multi-tab structure, parallel connections may be achieved among multi-layer electrode sheets. Compared with a conventional single-tab battery, the multi-tab battery has a greatly reduced internal resistance and significantly improved dynamic performances, such as improved discharge of rate, temperature rise and low temperature discharge. The multiple tabs are made of metal, and inner tabs cannot be directly packaged with a package. As a consequence, it is generally necessary to set a connecting tab and provide an adhesive thereon, and the encapsulation of the inner tabs is achieved by hot melting the adhesive and the package.

In the above structure, when a width of the battery and a distance between a positive tab and a negative tab are both large, the existence of the connecting tab will lead to a larger vacuum region between the positive tab and the negative tab, and this region collapses due to a difference between internal and external pressures when the batteries are vacuumized after formation, which results in insufficient rigid of the top seal and occurrence of wavy bending at the top seal. As a result, the distance between tabs is poor, which not only affects the appearance of the battery, but also affects the subsequent assembly between the battery and a protective plate, especially seriously affects the automatic assembly.

Therefore, the existing multi-tab battery still needs to be improved.

### SUMMARY

Embodiments of the present disclosure seek to solve at least one of the problems existing in the related art to at least some extent.

According to a first aspect of embodiments of the present disclosure, there is provided a battery, the battery includes an electrode assembly and a protective layer. The electrode assembly includes a first electrode sheet, a first tab, a second electrode sheet and a second tab. The first tab is electrically connected to the first electrode sheet, and the second tab is electrically connected to the second electrode sheet. The protective layer covers at least partial surface of the first tab and at least partial surface of the second tab.

In some embodiments, the first tab includes a first protruding part, a first extension par and a first connecting part. The first protruding part protrudes from the first electrode sheet, the first extension part is electrically connected to the first protruding part, the first connecting part electrically connects the first protruding part to the first extension part, and the first protruding part is located between the first electrode sheet and the first extension part. The second tab includes a second protruding part, a second extension part and a second connecting part. The second protruding part protrudes from the second electrode sheet, the second extension part is electrically connected to the second protruding part, the second connecting part electrically connects the second protruding part to the second extension part, and the second protruding part is located between the second electrode sheet and the second extension part. The protective layer includes a first section, a connecting section, and a second section. The first section covers at least partial surface of the first connecting part, and the second section covers at least partial surface of the second connecting part. The first section, the connecting section and the second section are connected in sequence in a length direction of the protective layer.

In some embodiments, the protective layer further includes an extension section located at an end of the protective layer and covering at least partial lateral surface of the electrode assembly.

In some embodiments, the first connecting part is formed by welding the first protruding part and the first extension part to achieve electrical connection between the first protruding part and the first extension part, and the first connecting part includes a first solder print, and a thickness of the first section is not less than 1.1 times of a protrusion height of the first solder print. The second connecting part is formed by welding the second protruding part and the second extension part to achieve electrical connection between the second protruding part and the second extension part, and the second connecting part includes a second solder print, and a thickness of the second section is not less than 1.1 times of a protruding height of the second solder print.

In some embodiments, the protective layer includes a first adhesive layer which is a double-sided adhesive layer and one side of which faces the first connecting part and the second connecting part.

In some embodiments, the first tab includes a plurality of the first protruding parts, and the second tab includes a plurality of the second protruding parts.

In some embodiments, the electrode assembly includes a plurality of the first electrode sheets and a plurality of the second electrode sheets.

In some embodiments, the battery further includes a second adhesive layer. The second adhesive layer is disposed at a position of at least one selected from: between the first electrode sheet and the second electrode sheet, on a side of the first electrode sheet and on a side of the second electrode sheet. The protective layer overlaps with the second adhesive layer.

In some embodiments, the protective layer further includes a third section connected to the connecting section and covering at least partial surface of the second adhesive layer.

In some embodiments, the battery includes a plurality of the first connecting parts and a plurality of the second connecting parts.

According to a second aspect of embodiments of the present disclosure, there is provided an electronic device, the electronic device includes the battery as described in any embodiment hereinbefore. Therefore, the electronic device has all of the features and advantages described above with respect to the battery, which will not be elaborated herein. In general, the electronic device has excellent performances and reliability.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a schematic diagram of a battery according to some embodiments of the present disclosure;

FIG. 2 is a schematic diagram of a battery according to some embodiments of the present disclosure;

FIG. 3 is a schematic diagram of a battery according to some embodiments of the present disclosure;

FIG. 4 is a schematic section view of a battery according to some embodiments of the present disclosure;

FIG. 5 is a schematic diagram of a protective layer in a battery according to some embodiments of the present disclosure;

FIG. 6 is a schematic diagram of a battery according to some embodiments of the present disclosure;

FIG. 7 is a schematic diagram of a battery according to some embodiments of the present disclosure;

FIG. 8 is a schematic diagram of a protective layer in a battery according to some embodiments of the present disclosure;

FIG. 9 is a schematic diagram of a battery according to some embodiments of the present disclosure; and

FIG. 10 is a schematic diagram of a battery according to some embodiments of the present disclosure.

### DETAILED DESCRIPTION

Reference will be made in detail to embodiments of the present disclosure, examples of which are illustrated in the accompanying drawings. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, it is to be understood that terms such as “central”, “longitudinal”, “lateral”, “length”, “width”, “thickness”, “upper”, “lower”, “front”, “rear”, “left”, “right”, “vertical”, “horizontal”, “top”, “bottom”, “inner” and “outer” should be construed to refer to the orientation as then described or as shown in the drawings under discussion. These relative terms are for convenience of description, but do not indicate or imply that the device or element referred to must have a particular orientation, or be constructed or operated in a particular orientation, and thus shall not be construed to limit the present disclosure.

In addition, terms such as “first” and “second” are used herein for purposes of description and are not intended to indicate or imply relative importance or significance or to imply the number of indicated technical features. Thus, the feature defined with “first” and “second” may expressly or implicitly includes one or more of this feature. In the description of the present invention, “a plurality of” means two or more than two, such as two or three, unless specified otherwise.

In the present invention, unless specified or limited otherwise, the terms “mounted”, “connected”, “coupled”, “fixed” and the like are used broadly, and may be, for example, fixed connections, detachable connections, or integral connections; may also be mechanical or electrical connections; may also be direct connections or indirect connections via intervening structures; may also be inner communications or interactions of two elements, which can be understood by those skilled in the art according to specific situations.

A battery as described in embodiments of the present disclosure includes all devices in which an electrochemical reaction occurs. Specifically, the battery includes all kinds of primary batteries, secondary batteries, fuel batteries, solar batteries, and capacitors, such as supercapacitors. Preferred are lithium secondary batteries, including lithium metal secondary batteries, lithium ion secondary batteries, lithium polymer secondary batteries, and lithium ion polymer secondary batteries.

The inventors found in the study of battery tabs that a connecting tab used in an existing multi-tab battery for connecting a plurality of inner tabs is prone to tilt, which not only affects the appearance of the battery, but also affects the subsequent assembly between the battery and the protective plate, especially seriously affects the automatic assembly. The inventors discovered through in-depth research that the main reason for this problem is that, in order to reduce space occupied by the connecting tab in a length direction of the cell and facilitate the development of energy density, the connecting tab generally needs to be folded into a U-shape, so that a welding surface of the tabs is changed to be perpendicular to instead of parallel to the surface of the cell. In the above structure, when a width of the battery and a distance between a positive tab and a negative tab are both large, the existence of the connecting tab will lead to a larger vacuum region between the positive tab and the negative tab. In the related art, the tabs are usually fixed by taking advantage of adhesives on the welding surfaces of the positive and negative tabs, such a manner, however, cannot stably fix the positive and negative tabs. As a result, when the battery is vacuumized after formation, a region between the positive tab and the negative tab collapses due to a difference between internal and external pressures, which results in insufficient rigid of the top seal and occurrence of wavy bending at the top seal, and the positive and negative tabs may thereby recess inwardly in a width direction of the cell, resulting in the tabs to slant.

In view of this, in a first aspect of embodiments of the present disclosure, there is provided a battery. As illustrated in FIG. 1, the battery includes a first electrode sheet 100, a first tab 110, a second electrode sheet 200, a second tab 210 and a protective layer 300. The first tab 110 is electrically connected to the first electrode sheet 100. The second tab 210 is electrically connected to the second electrode sheet 200. The protective layer 300 covers at least partial surface of the first tab 110 and at least partial surface of the second tab 210.

For convenience of description, in the present disclosure, a structure in which the first electrode sheet 100 and the second electrode sheet 200 are stacked or wound is referred to as an electrode assembly.

In the battery according to embodiments of the present disclosure, by covering at least partial surface of the first tab and at least partial surface of the second tab with the protective layer, the fixing stability of the tabs are significantly improved, and slant of the tabs in the subsequent process are avoided.

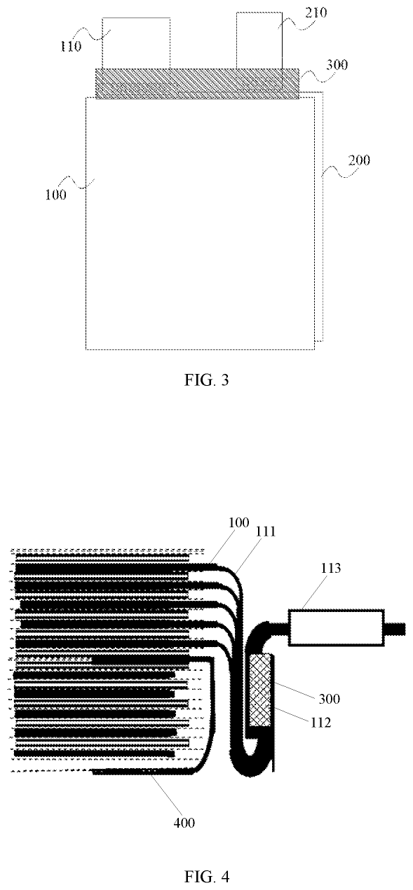

In the following, the battery according to embodiments of the present disclosure will be described in detail with reference to FIGS. 1-10.

In some embodiments of the present disclosure, the protective layer 300 is not particularly limited to a specific type, as long as it may effectively cover at least partial surface of the first tab 110 and at least partial surface of the second tab 210 simultaneously so as to fix the first tab 110 and the second tab 210. In a specific embodiment of the present disclosure, the protective layer 300 may adopt a common adhesive layer in the related art. In this way, both the first tab 110 and the second tab 210 are covered and fixed by the adhesive layer, thereby effectively improving the fixing effect of the tabs. In addition, in some embodiments, the adhesive layer has a viscosity not less than 0.18 N/mm, and will not fall off even immersed in an electrolyte. In this way, the fixing effect of the tabs may be further improved.

In some embodiments of the present disclosure, a part of the protective layer 300 may be covered on the first electrode sheet or the second electrode sheet. It will be understood by those skilled in the art that, the electrode sheet of the battery may be provided with a separator or an electrode active material. Therefore, in some embodiments, the protective layer 300 may be directly covered on the first electrode sheet or the second electrode sheet. In some other embodiments, the protective layer 300 may be covered on the separator or the electrode active material on a surface of the electrode sheet.

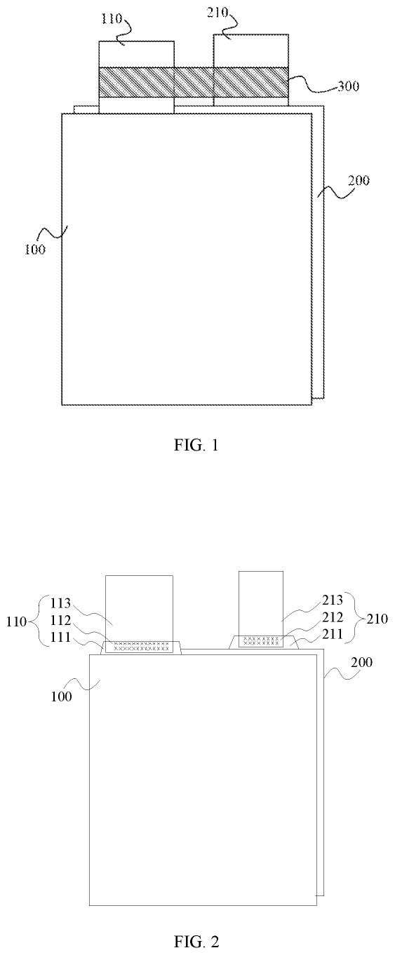

In some embodiments of the present disclosure, as illustrated in FIGS. 2-4, the first tab 110 includes a first protruding part 111, a first connecting part 112, and a first extension part 113. The first protruding part 111 protrudes from the first electrode sheet 100, and the first protruding part 111 is located between the first electrode sheet 100 and the first extension part 113. The first extension part 113 is electrically connected to the first protruding part 111. A region where the first protruding part 111 and the first extension part 113 are electrically connected is the first connecting part 112. The second tab 210 includes a second protruding part 211, a second connecting part 212, and a second extension part 213. The second protruding part 211 protrudes from the second electrode sheet 200, and the second protruding part 211 is located between the second electrode sheet 200 and the second extension part 213. The second extension part 213 is electrically connected to the second protruding part 211. A region where the second protruding part 211 and the second extension part 213 are electrically connected is the second connecting part 212. It should be noted that, the protective layer 300 is not shown in FIG. 2.

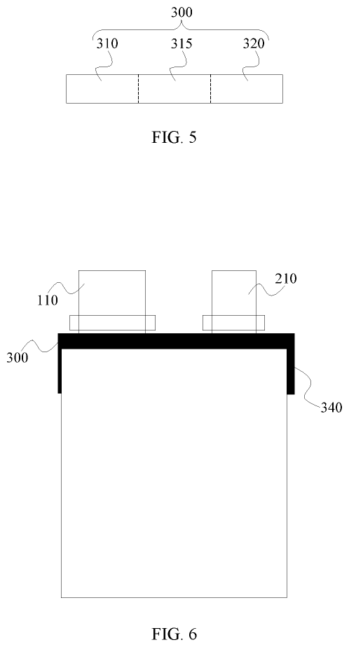

In some embodiments of the present disclosure, as illustrated in FIG. 5, the protective layer 300 includes a first section 310, a connecting section 315, and a second section 320 connected in sequence in a length direction of the protective layer 300. The first section 310 covers at least partial surface of the first connecting part 112, and the second section 320 covers at least partial surface of the second connecting part 212.

In addition, it should be noted that, a connection position of the first tab 110 on the first electrode sheet 100 and a connection position of the second tab 210 on the second electrode sheet 200 are not particularly limited. In some embodiments, the first tab 110 and the second tab 210 may be disposed at a same side of the electrode assembly or at a different side of the electrode assembly. In some embodiments, the battery may include a plurality of the first tabs 110 or a plurality of the second tabs 210, and the plurality of the first tabs 110 may be disposed at a same side of the first electrode sheet 100 or at a different side of the first electrode sheet 100, and the second tabs 210 may also be disposed in a same manner.

In some embodiments of the present disclosure, as illustrated in FIG. 6, two ends of the protective layer 300 respectively extend to a lateral surface of at least one of the first electrode sheet 100 and the second electrode sheet 200, and the part of the protective layer 300 which is located at the lateral surface of at least one of the first electrode sheet 100 and the second electrode sheet 200 is referred to as an extension section 340. Herein, it should be noted that, the battery provided in embodiments of the present disclosure may have a stacked structure or a wound structure. For the battery having the stacked structure, the extension section is located on a side surface of a main body of the electrode assembly. For the battery having the wound structure, the extension section is located on a (front or back) surface of the first electrode sheet or the second electrode sheet.

In some embodiments of the present disclosure, the first connecting part 112 is formed by welding the first protruding part 111 and the first extension part 113 to achieve electrical connection between the first protruding part 111 and the first extension part 113. The first connecting part 112 includes a first solder print, and a thickness of the first section 310 of the protective layer 300 is not less than 1.1 times of a protruding height of the first solder print. The second connecting part 212 is formed by welding the second protruding part 211 and the second extension part 213 to achieve electrical connection between the second protruding part 211 and the second extension part 213. The second connecting part 212 includes a second solder print, and a thickness of the second section 320 of the protective layer 300 is not less than 1.1 times of a protruding height of the second solder print. By setting the thicknesses of the first and second sections of the protective layer within the above-mentioned range, the fixing effect of the protective layer on the tabs may be further improved, while the solder prints are protected, thereby further improving the reliability of the battery.

According to embodiments of the present disclosure, the protective layer 300 is not particularly limited to a specific size, as long as it may effectively cover at least partial surface of the first tab and at least partial surface of the second tab at the same time. In some embodiments, a width of the connecting section 315 of the protective layer 300 may be configured to be not less than 10% of a distance between the first tab 110 and the second tab 210. In this way, the fixing effects of the protective layer 300 on the first tab and the second tab may be further improved.

In some embodiments of the present disclosure, the protective layer 300 may include a first adhesive layer which is a double-sided adhesive layer. One side of the double-sided adhesive layer faces the first connecting part 112 and the second connecting part 212, so as to bond with and fix the first connecting part 112 and the second connecting part 212 at the same time, and the other side of the double-sided adhesive layer may bond with a packaging film (such as an aluminum foil) of the battery. In this way, the first connecting part 112 of the first tab 110 and the second connecting part 212 of the second tab 210 may be fixed to the packaging film of the battery by the double-sided adhesive layer, thereby further improving the fixing stability of the first tab and the second tab.

In some embodiments of the present disclosure, the first tab 110 includes a plurality of the first protruding parts 111, and the second tab 210 includes a plurality of the second protruding parts 211.

It should be illustrated that, the electrode assembly provided in embodiments of the present disclosure may have a stacked structure or a wound structure. In some embodiments of the present disclosure, in the battery having the wound structure, a single first electrode sheet 100 and a single second electrode sheet 200 overlap and are wound along a rotation axis to form a multi-layer structure in which the first electrode sheet layer and the second electrode sheet layer are alternately arranged. In some embodiments of the present disclosure, in the battery having the stacked structure, the electrode assembly includes a plurality of the first electrode sheets 100 and a plurality of the second electrode sheets 200, which overlap and are alternately arranged to form a multi-layer structure. In the case that the electrode assembly includes a plurality of the first electrode sheets 100 and a plurality of the second electrode sheets 200, correspondingly, the electrode assembly also includes a plurality of the first tabs 110 and a plurality of the second tabs 210.

In some embodiments of the present disclosure, as illustrated in FIG. 4, the battery further includes additional adhesive layers. The additional adhesive layers include a second adhesive layer 400 and a third adhesive layer (not shown in drawings). The second adhesive layer 400 is disposed at a position of at least one selected from: between adjacent first electrode sheets 100, between adjacent second electrode sheets 200, between the first electrode sheet 100 and the second electrode sheet 200 which are adjacent to each other, on a side of the first electrode sheet 100, and on a side of the second electrode sheet 200. The third adhesive layer is disposed on a plurality of the first tab 110 or a plurality of the second tab 210. The second adhesive layer may further improve the fixing stability of the electrode sheets in the battery, and at the same time, the second adhesive layer disposed between the adjacent first electrode sheets 100 or between the adjacent second electrode sheets 200 may play a separating role therebetween. The third adhesive layer may improve the fixing stability of the tabs. In some embodiments, the third adhesive layer is disposed on the first protruding part 111 of the first tab 110 or the second protruding part 211 of the second tab 210. In addition, it should be noted that, in the battery having the wound structure, the multi-layer structure of the electrode sheets is formed by winding the single first electrode sheet 100 and the single second electrode sheet 200, in such a case, the second adhesive layer 400 is disposed at a position of at least one selected from: between two adjacent layers of the first electrode sheet 100, between two adjacent layers of the second electrode sheet 200, between the first electrode sheet 100 and the second electrode sheet 200 which are adjacent to each other, on a side of the first electrode sheet 100, and on a side of the second electrode sheet 200. In the battery having the stacked structure, a plurality of the first electrode sheets 100 and a plurality of the second electrode sheet 200 overlap and are alternately arranged, in such a case, the second adhesive layer 400 is disposed at a position of at least one selected from: between two adjacent first electrode sheets 100, between two adjacent second electrode sheets 200, on a side of the first electrode sheet 100, and on a side of the second electrode sheet 200.

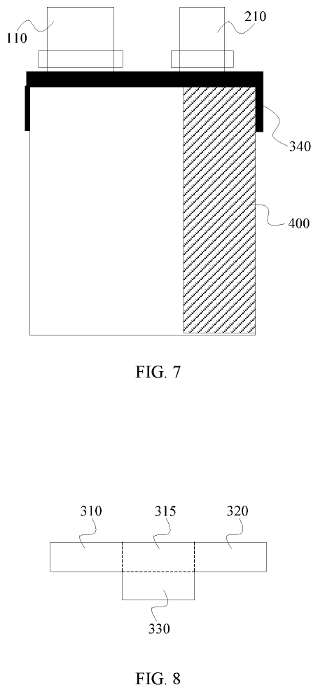

In addition, the second adhesive layer 400 disposed on the side of the first electrode sheet 100 and/or on the side of the second electrode sheet 200 may be attached as an ending adhesive to the surface of the electrode assembly. In some embodiments of the present disclosure, as illustrated in FIG. 7, by controlling the size of the extension section 340 of the protective layer 300, the extension section 340 may be controlled to overlap or not overlap with the ending adhesive. When the extension section 340 does not overlap with the ending adhesive, an energy density of the battery may be improved. When the extension section 340 overlaps with the ending adhesive, the fixing stability of the first tab and the second tab may be further improved in relative to the case where the extension section 340 does not overlap with the ending adhesive. For a small battery with a capacity less than 500 mAh, a force required for fixing the first tab and the second tab is smaller, and the energy density is required to be higher, and thus a design where the extension section 340 does not overlap with the ending adhesive is preferred. For a larger battery with a capacity greater than 500 mAh, the force required for fixing the first tab and the second tab is larger, and thus a design where the extension section 340 overlaps with the ending adhesive is preferred, but in a protruding direction of the tab, the overlapped size is not greater than one tenth of the ending adhesive.

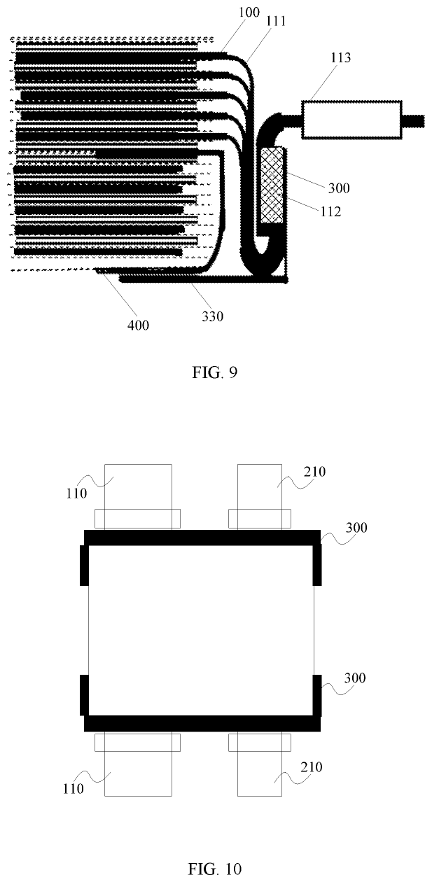

In some embodiments of the present disclosure, as illustrated in FIGS. 8-9, the protective layer 300 further includes a third section 330 connected to the connecting section 315 and covering at least partial surface of the second adhesive layer 400. By providing the third section 330 at a position connected with the connecting section 315 of the protective layer 300, on the one hand, the third section 330 may partially overlaps with the second adhesive layer 400 to improve the fixing stability of the protective layer 300; on the other hand, the wrinkle problem that may occur when the protective layer 300 covers a junction of the surface and side edge of the electrode sheet may be effectively solved.

In some embodiments of the present disclosure, the battery includes a plurality of the first connecting parts 112 and a plurality of the second connecting parts 212. That is, in the battery provided in the present disclosure, one first electrode sheet may be electrically connected with a plurality of the first tabs, and one second electrode sheet may be electrically connected with a plurality of the second tabs. As illustrated in FIG. 10, the first tab and the second tab located at the same side of the electrode sheets are fixed by the protective layer 300, thereby meeting the needs of the battery in different application scenarios, such as in different types of electronic devices.

In some embodiments of the present disclosure, the above mentioned protective layer 300 which covers both the first tab and the second tab does not have a particularly limit to the structure of tabs, and may be applied to a folded or unfolded tab commonly used in the related art. In a battery having the folded tab, by covering the first tab and the second tab with the protective layer 300, the space of the folded tab may be effectively reduced while ensuring the fixing stability of the first and second tabs, thereby improving the energy density of the battery cell.

In addition, in a second aspect of embodiments of the present disclosure, there is provided an electronic device, the electronic device includes the battery as described in any embodiment hereinbefore. Therefore, the electronic device has all of the features and advantages described above with respect to the battery, which will not be elaborated herein. In general, the electronic device has excellent performances and reliability.

Reference throughout this specification to “an embodiment”, “some embodiments”, “one embodiment”, “an example”, “a specific example” or “some examples” means that a particular feature, structure, material, or characteristic described in connection with the embodiment or example is included in at least one embodiment or example of the present disclosure. Thus, the appearances of the phrases such as “in some embodiments”, “in one embodiment”, “in an embodiment”, “in an example”, “in a specific example” or “in some examples,” in various places throughout this specification are not necessarily referring to the same embodiment or example of the present disclosure. Furthermore, the particular features, structures, materials, or characteristics may be combined in any suitable manner in one or more embodiments or examples. In addition, in the absence of contradiction, those skilled in the art can combine the different embodiments or examples described in this specification, or combine the features of different embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A battery, comprising:
an electrode assembly, comprising:
a first electrode sheet;
a first tab electrically connected to the first electrode sheet;
a second electrode sheet; and
a second tab electrically connected to the second electrode sheet, and
a protective layer, covering at least partial surface of the first tab and at least partial surface of the second tab.

2. The battery according to claim 1, wherein
the first tab comprises:
a first protruding part, protruding from the first electrode sheet;
a first extension part, electrically connected to the first protruding part; and a first connecting part, electrically connecting the first protruding part to the first extension part, wherein the first protruding part is located between the first electrode sheet and the first extension part,
the second tab comprises:
a second protruding part, protruding from the second electrode sheet;
a second extension part, electrically connected to the second protruding part; and
a second connecting part, electrically connecting the second protruding part to the second extension part, wherein the second protruding part is located between the second electrode sheet and the second extension part, and
the protective layer comprises:
a first section, covering at least partial surface of the first connecting part;
a connecting section; and
a second section, covering at least partial surface of the second connecting part,
the first section, the connecting section and the second section being connected in sequence in a length direction of the protective layer.

3. The battery according to claim 1, wherein the protective layer comprises an extension section located at an end of the protective layer and covering at least partial lateral surface of the electrode assembly.

4. The battery according to claim 2, wherein the first connecting part is formed by welding the first protruding part and the first extension part to achieve electrical connection between the first protruding part and the first extension part, and the first connecting part comprises a first solder print, and a thickness of the first section is not less than 1.1 times of a protruding height of the first solder print;
the second connecting part is formed by welding the second protruding part and the second extension part to achieve electrical connection between the second protruding part and the second extension part, and the second connecting part comprises a second solder print, and a thickness of the second section is not less than 1.1 times of a protruding height of the second solder print.

5. The battery according to claim 2, wherein the protective layer comprises a first adhesive layer which is a double-sided adhesive layer and one side of which faces the first connecting part and the second connecting part.

6. The battery according to claim 2, wherein the first tab comprises a plurality of the first protruding parts, and the second tab comprises a plurality of the second protruding parts.

7. The battery according to claim 1, wherein the electrode assembly comprises a plurality of the first electrode sheets and a plurality of the second electrode sheets.

8. The battery according to claim 2, further comprising: a second adhesive layer disposed at a position of at least one selected from: between the first electrode sheet and the second electrode sheet, on a side of the first electrode sheet and on a side of the second electrode sheet,
wherein the protective layer overlaps with the second adhesive layer.

9. The battery according to claim 8, wherein the protective layer further comprises a third section connected to the connecting section and covering at least partial surface of the second adhesive layer.

10. The battery according to claim 2, wherein the battery comprises a plurality of the first connecting parts and a plurality of the second connecting parts.

11. The battery according to claim 5, wherein the battery comprises a plurality of the first connecting parts and a plurality of the second connecting parts.

12. The battery according to claim 1, further comprising a third adhesive layer disposed on the first tab or the second tab.

13. The battery according to claim 1, comprising a plurality of the first tabs and a plurality of the second tab.

14. The battery according to claim 13, wherein the first electrode sheet is electrically connected to the plurality of the first tabs, and the second electrode sheet is electrically connected to the plurality of the second tabs.

15. The battery according to claim 1, wherein the battery has a wound structure or a stacked structure.

16. The battery according to claim 15, wherein the battery has the wound structure, and comprises a single first electrode sheet and a single second electrode sheet which overlap and are wound along a rotation axis to form a multi-layer structure.

17. The battery according to claim 16, further comprising:
a second adhesive layer disposed at a position of at least one selected from:
between two adjacent layers of the first electrode sheet, between two adjacent layers of the second electrode sheet, between the first electrode sheet and the second electrode sheet, on a side of the first electrode sheet, and on a side of the second electrode sheet.

18. The battery according to claim 15, wherein the battery has the stacked structure, and the electrode assembly comprises a plurality of the first electrode sheets and a plurality of the second electrode sheets which overlap and are alternately arranged to form a multi-layer structure.

19. The battery according to claim 18, further comprising:
a second adhesive layer disposed at a position of at least one selected from:
between two adjacent first electrode sheets, between two adjacent second electrode sheets, on a side of the first electrode sheet, and on a side of the second electrode sheet.

20. An electronic device, comprising a battery, wherein the battery comprises:
an electrode assembly, comprising:
a first electrode sheet;
a first tab electrically connected to the first electrode sheet;
a second electrode sheet; and
a second tab electrically connected to the second electrode sheet, and
a protective layer, covering at least partial surface of the first tab and at least partial surface of the second tab.
